(19) United States
(12) Patent Application Publication
(10) Pub. No.: US 2026/0078600 A1
(43) Pub. Date: Mar. 19, 2026

(54) UMBRELLA HOLDING DEVICE

(71) Applicant: Gary J Schorr, Mesa, AZ (US)

(72) Inventor: Gary J Schorr, Mesa, AZ (US)

(21) Appl. No.: 19/401,634

(22) Filed: Nov. 26, 2025

Related U.S. Application Data
(63) Continuation-in-part of application No. 18/811,948, filed on Aug. 22, 2024, now Pat. No. 12,523,054.
(60) Provisional application No. 63/534,054, filed on Aug. 22, 2023.

(51) Int. Cl. E04H 12/22; F16B 7/14

(52) U.S. Cl. CPC E04H 12/2269; F16B 7/149

(57) ABSTRACT

An umbrella holding device for securing an umbrella in a patio hole includes a grip nut with a threaded interior and a shoulder, a base with a threaded grip portion and a patio extension, a removable thread sleeve that slides over the patio extension, and a ferrule. The ferrule is inserted into the grip nut and, when the grip nut engages the base, the ferrule is compressed into the funnel-shaped base interior to grip the umbrella shaft. The removable thread sleeve, made of pliable material, slides over the patio extension and compresses against the patio hole when threaded in, creating a friction hold. Multiple thread sleeves of different dimensions and materials can be provided to accommodate various patio hole sizes and conditions.

### CROSS REFERENCE

This continuation-in-part claims benefit from currently pending U.S. Nonprovisional patent application Ser. No. 18/811,948 titled “Umbrella Holding Device” having a filing date of Aug. 22, 2024, which in turn claims priority to U.S. Provisional Application No. 63/534,054 titled “Umbrella Holding Device” and having a filing date of Aug. 22, 2023, all of which is incorporated by reference herein.

### FIELD OF THE INVENTION

The present specification relates generally to a device for holding an umbrella and more particularly an umbrella holding device that securely holds an umbrella in hole that is on a patio, deck or pool deck.

### BACKGROUND OF THE INVENTION

Various methods and devices have been developed in the field of outdoor accessories to secure umbrellas in outdoor environments. While traditional solutions have provided means of anchoring and supporting umbrellas, they often suffer from limitations in terms of portability, stability, and ease of use. Traditional methods of securing umbrellas in outdoor settings often involve heavy stands or bases, which can be cumbersome to transport and set up. These stands may also limit the mobility of users by confining them to specific areas, such as patios, decks or pool decks. Moreover, the complexity of assembly and disassembly, especially for larger umbrellas, presents challenges for users seeking a hassle-free outdoor experience.

In response to these challenges, various umbrella holders have been introduced in the market. Some of these holders rely on clamping mechanisms that attach to existing fixtures, such as tables or railings. While these designs offer convenience, they are restricted to specific locations and may not provide the desired stability in various ground conditions. One common approach to securing umbrellas outdoors involves the use of stands or bases that provide a stable foundation. These stands are usually made of heavy materials, such as metal or concrete, to counterbalance the weight of the umbrella and provide stability. While effective, these stands can be bulky and challenging to transport, limiting their utility in situations where portability is essential. Furthermore, the assembly and disassembly of these stands can be time-consuming and inconvenient for users seeking a quick setup.

Another category of umbrella holders includes clamp-on designs that attach to existing structures such as tables, railings, or fences. These holders offer convenience by leveraging pre-existing fixtures to support the umbrella. However, these solutions are location-dependent and often require specific fixtures to be available. Additionally, their suitability is limited to environments where compatible fixtures are present, restricting their versatility. Certain umbrella holders rely on anchors or stakes that are driven into the ground to secure the umbrella. While these solutions offer improved portability compared to traditional stands, they can face challenges in terms of stability, particularly in loose or sandy soil. Additionally, many of these designs lack adaptability to accommodate different umbrella sizes and may not provide the desired stability during inclement weather conditions.

Common shortcomings across existing umbrella holder designs include limitations in adaptability to diverse ground conditions, cumbersome assembly procedures, and constraints in providing both portability and stability simultaneously. Users often find it challenging to strike a balance between convenience and performance when selecting an umbrella holder solution that suits their needs.

As a result, there exists a need for a novel umbrella holder design that offers a practical solution to securely and conveniently anchor umbrellas in various outdoor settings, while overcoming the limitations of existing solutions.

### BRIEF SUMMARY OF THE INVENTION

The present invention generally an umbrella holding device can be provided for securing an umbrella in a patio hole on a patio, porch or pool deck. The holding device can include a grip nut having a grip exterior, a grip interior that defines a grip hollow, and a shoulder extending from the grip exterior into the grip hollow defining a shoulder diameter, wherein the grip interior can be at least partially threaded with a grip nut thread. The device can include a base having a grip portion on a grip end and a patio extension on a patio end, wherein the grip portion can have an at least partially threaded exterior portion configured to engage the grip nut thread and a base interior that can be substantially funnel shaped. A threaded sleeve can be provided that slides over the patio extension and may be adhered to the patio extension to give the patio extension an at least partially threaded exterior.

The device can also include a ferrule having a ferrule top and at least one tang, wherein the ferrule can be configured to be inserted into the grip hollow such that the ferrule top engages the shoulder such that when the threaded exterior portion engages the grip nut thread the ferrule is pushed into the base interior and the funnel shaped base interior exerts inward pressure on the ferrule. The thread sleeve can be composed of a pliable material that compresses against the patio extension when the patio extension with the thread sleeve is threaded into the patio hole to create a friction hold that holds the patio extension in the patio hole. The pliable material can be at least one of rubber, Buna-N, thermoplastic copolyester and thermoplastic polyurethane.

The at least partially threaded exterior portion of the grip portion can have a grip external diameter, and the base can have a flare that extends past the grip external diameter in a direction orthogonal to the direction that the patio extension extends from the grip portion. The flare can have a lip and a hollow that together define a collar into which the thread sleeve fits when the patio extension is fully inserted into the thread sleeve. The flare can extend past the grip exterior and can extend between 70 and 100 mm.

The thread sleeve can have a sleeve thread, and the sleeve thread can have a flat top. The sleeve thread can extend between 25 and 50 mm. The thread sleeve can have a sleeve inner diameter and the patio extension can have an extension outer diameter, wherein the sleeve inner diameter can equal the extension outer diameter. Alternatively, the extension outer diameter can be 0.76 mm greater than the sleeve inner diameter. The patio extension can have an extension outer diameter between 40 and 50 mm. The thread sleeve can have a hardness between Shore 30 and 95 on the durometer hardness scale. The patio extension can have a thickness between 1.5 and 3 mm.

A method can be provided for providing an umbrella holding device for securing an umbrella in a patio hole on a patio, porch or pool deck to a user. The method can include providing a grip nut having a grip exterior, a grip interior that defines a grip hollow, and a shoulder extending from the grip exterior into the grip hollow defining a shoulder diameter wherein the grip interior is at least partially threaded with a grip nut thread; a base having a grip portion on a grip end and a patio extension on a patio end, wherein the grip portion has an at least partially threaded exterior portion configured to engage the grip nut thread and a base interior that is substantially funnel shaped; at least one removable thread sleeve that slides over the patio extension to give the patio extension an at least partially threaded exterior; and a ferrule having a ferrule top and at least one tang, the ferrule configured to be inserted into the grip hollow such that the ferrule top engages the shoulder such that when the threaded exterior portion engages the grip nut thread the ferrule is pushed into the base interior and the funnel shaped base interior exerts inward pressure on the ferrule. The ferrule can be replaceable to accommodate different size umbrellas.

The method can further include instructing the user to adhere the thread sleeve onto the patio extension and thread the patio extension into a patio hole. The at least one removable thread sleeve can be a plurality of removable thread sleeves of differing dimensions, allowing the user to select an appropriate thread sleeve. The at least one removable thread sleeve can be a plurality of removable thread sleeves made of differing materials, allowing the user to select an appropriate thread sleeve.

Aspects and applications of the invention presented here are described below in the drawings and detailed description of the invention. Unless specifically noted, it is intended that the words and phrases in the specification and the claims be given their plain, ordinary, and accustomed meaning to those of ordinary skill in the applicable arts. The inventors are fully aware that they can be their own lexicographers if desired. The inventors expressly elect, as their own lexicographers, to use only the plain and ordinary meaning of terms in the specification and claims unless they clearly state otherwise and then further, expressly set forth the. Absent such clear statements of intent to apply a “special” definition, it is the inventor's intent and desire that the simple, plain, and ordinary meaning to the terms be applied to the interpretation of the specification and claims.

The inventors are also aware of the normal precepts of English grammar. Thus, if a noun, term, or phrase is intended to be further characterized, specified, or narrowed in some way, then such noun, term, or phrase will expressly include additional adjectives, descriptive terms, or other modifiers in accordance with the normal precepts of English grammar. Absent the use of such adjectives, descriptive terms, or modifiers, it is the intent that such nouns, terms, or phrases be given their plain, and ordinary English meaning to those skilled in the applicable arts as set forth above.

Further, the inventors are fully informed of the standards and application of the special provisions of 35 U.S.C. § 112(f). Thus, the use of the words “function,” “means” or “step” in the Detailed Description or Description of the Drawings or claims is not intended to somehow indicate a desire to invoke the special provisions of 35 U.S.C. § 112(f), to define the invention. To the contrary, if the provisions of 35 U.S.C. § 112(f) are sought to be invoked to define the inventions, the claims will specifically and expressly state the exact phrases “means for” or “step for” and will also recite the word “function” (i.e., will state “means for performing the function of . . . , without also reciting in such phrases any structure, material or act in support of the function. Thus, even when the claims recite a “means for performing the function of molding a . . . , step for performing the function of molding a . . . ,” if the claims also recite any structure, material or acts in support of that means or step, or that perform the recited function, then it is the clear intention of the inventors not to invoke the provisions of 35 U.S.C. § 112(f). Moreover, even if the provisions of 35 U.S.C. § 112(f) are invoked to define the claimed inventions, it is intended that the inventions not be limited only to the specific structure, material or acts that are described in the preferred embodiments, but in addition, include any and all structures, materials or acts that perform the claimed function as described in alternative embodiments or forms of the invention, or that are well known present or later-developed, equivalent structures, material or acts for performing the claimed function.

Additional features and advantages of the present specification will become apparent to those skilled in the art upon consideration of the following detailed description of the illustrative embodiment exemplifying the best mode of carrying out the invention as presently perceived.

### BRIEF DESCRIPTION OF THE DRAWINGS

These and other features, aspects, and advantages of the present specification will become better understood with regard to the following description, appended claims, and accompanying drawings where:

FIG. 1 is an isometric view of the umbrella holding device in a hole on a patio, porch or pool deck in accordance to one, or more embodiments;

FIG. 2 is an isometric view of the umbrella holding device in accordance to one, or more embodiments;

FIG. 3 is a bottom view of the umbrella holding device in accordance to one, or more embodiments;

FIG. 4a is a side view of the umbrella holding device in accordance to one, or more embodiments;

FIG. 4b is a cross-sectional view of FIG. 4a of the umbrella holding device in accordance to one, or more embodiments;

FIG. 5 is a top view of the umbrella holding device in accordance to one, or more embodiments;

FIG. 6a is an exploded side view of the umbrella holding device in accordance to one, or more embodiments;

FIG. 6b is an exploded cross-sectional view of FIG. 6a of the umbrella holding device in accordance to one, or more embodiments;

FIG. 7 is an isometric exploded view of the umbrella holding device in accordance to one, or more embodiments;

FIG. 8a is a side view of the umbrella holding device in a hole in accordance to one, or more embodiments;

FIG. 8b is a cross-sectional view of FIG. 8a of the umbrella holding device in a hole in accordance to one, or more embodiments;

FIG. 9a is a side view of another embodiment of the umbrella holding device in accordance to one, or more embodiments;

FIG. 9b is a cross-sectional view of FIG. 9a of another embodiment of the umbrella holding device in accordance to one, or more embodiments;

FIG. 10 is an isometric view of another embodiment of the umbrella holding device in a hole on a patio, porch or pool deck in accordance to one, or more embodiments;

FIG. 11a is a side view of another embodiment of the umbrella holding device in a hole on a patio, porch or pool deck in accordance to one, or more embodiments;

FIG. 11b is a cross-sectional view of FIG. 11a of another embodiment of the umbrella holding device in a hole on a patio, porch or pool deck in accordance to one, or more embodiments; and

FIG. 11c is a close-up view of FIG. 11b of another embodiment of the umbrella holding device in a hole on a patio, porch or pool deck in accordance to one, or more embodiments.

Elements and acts in the figures are illustrated for simplicity and have not necessarily been rendered according to any particular sequence or embodiment.

### DETAILED DESCRIPTION

In the following description, and for the purposes of explanation, numerous specific details are set forth in order to provide a thorough understanding of the various aspects of the invention. It will be understood, however, by those skilled in the relevant arts, that the present invention may be practiced without these specific details. In other instances, known structures and devices are shown or discussed more generally in order to avoid obscuring the invention. In many cases, a description of the operation is sufficient to enable one to implement the various forms of the invention, particularly when the operation is to be implemented in software. It should be noted that there are many different and alternative configurations, devices and technologies to which the disclosed inventions may be applied. The full scope of the inventions is not limited to the examples that are described below.

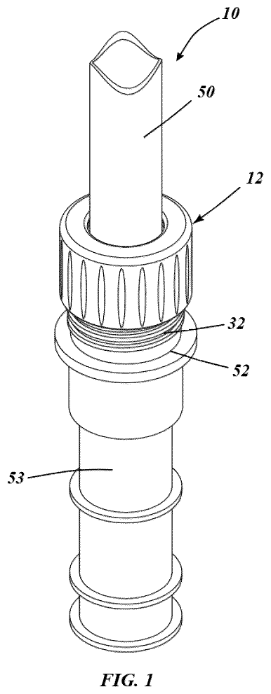

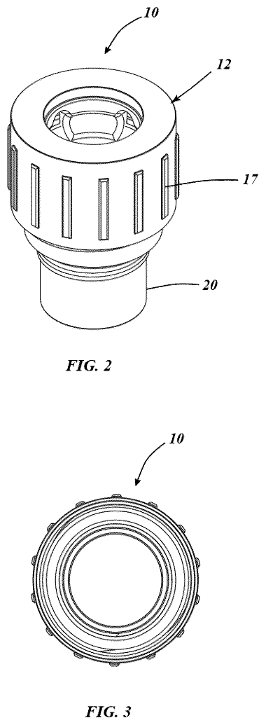

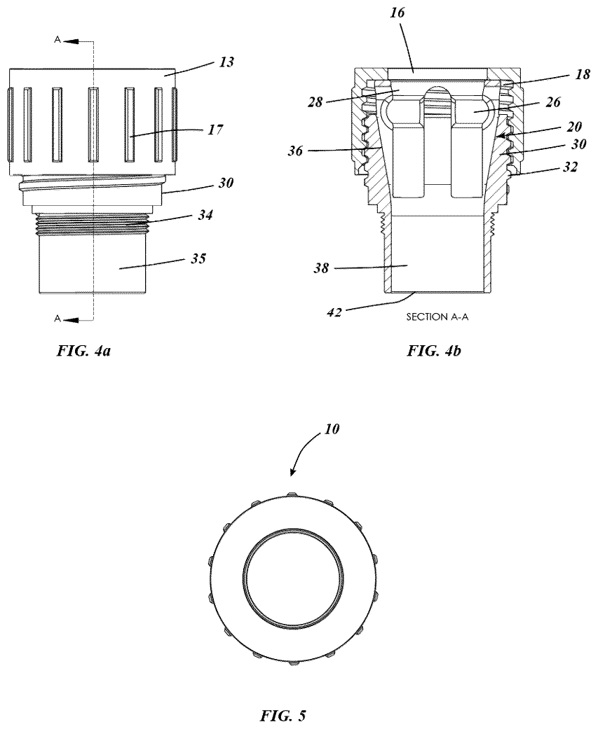

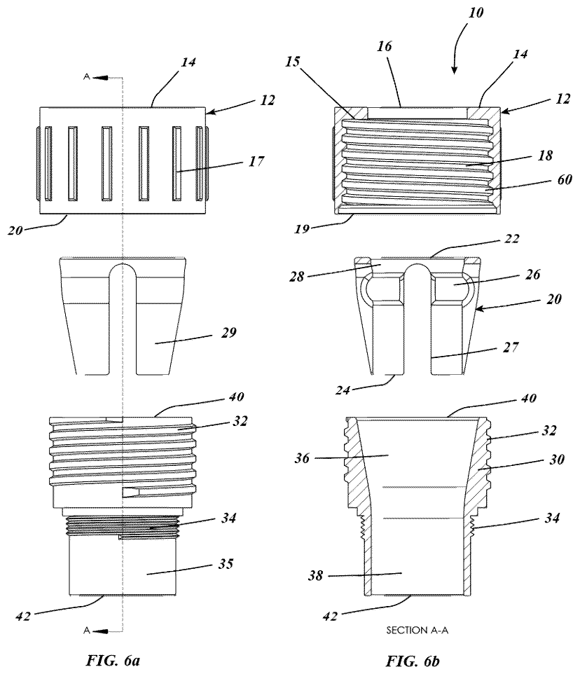

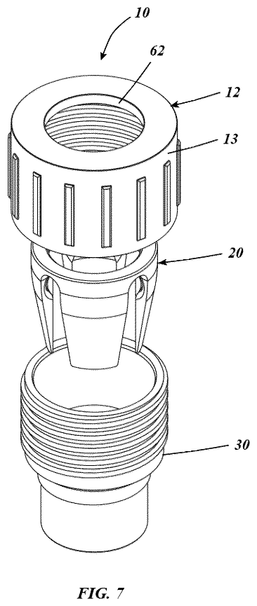

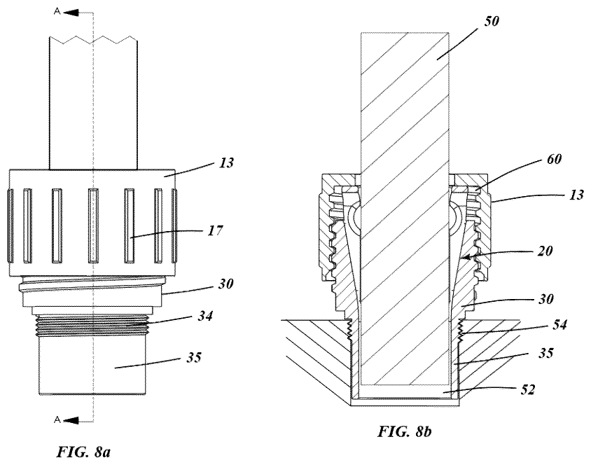

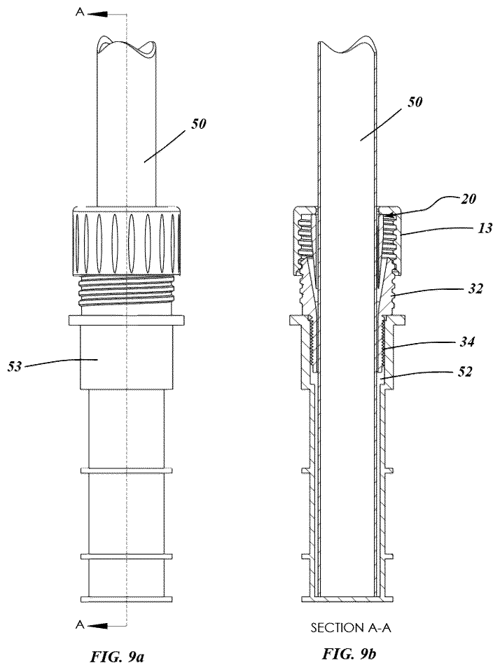

Referring to FIG. 1-9b, an umbrella holding device for securing an umbrella in a hole 52 on a porch, patio or pool deck is shown generally at 10 wherein a hole can have an umbrella hole insert 53. The hole 52 location is not limited to a porch, patio or pool deck, the hole can be in but not limited to, such as, for example, wooden deck, lawn or garden, concrete pad, sand or beach area, campground site, balcony or terrace, or the like.

The umbrella holding device 10 can comprise a grip nut 12 that can have a grip exterior 13 and a grip interior 61 that defines a grip hollow defining a shoulder diameter 62 wherein the grip interior is at least partially threaded with grip nut threads 18. The grip nut 12 can have a grip top 14 and a grip bottom 19. The grip top 14 can have a first thru hole 16 and the grip bottom 19 can have the grip nut threads 18 wherein the first through hole and the shoulder diameter 62 can define a shoulder 15. The grip nut 12 can be any suitable size or shape, but in the preferred embodiment the grip nut is circular or in other embodiments the grip nut can be such as, for example, circular, square, rectangular, oval, hexagonal, or the like in shape. The grip nut 12 can be made from such as, for example, stainless steel, plastic, carbon fiber, composite material, ceramics, wood, or the like.

The grip exterior 13 can have at least one grip extrusion 17 spaced evenly or unevenly around the grip exterior. The grip extrusion 17 can extend from the grip exterior 13 of the grip nut 12 wherein the grip extrusion can be such as, for example, a long narrow rectangle grip, hill knurled, mountain knurled, triangular grip or the like. The transition between the first hole 16 and the first threads 18 can form a shoulder 15. The grip nut threads 18 can be such as, for example, acme threads, national pipe thread, British standard pipe threads, ISO metric screw thread or the like. In other embodiments, the grip nut 12 can have a locking mechanism such as a push tab that can slidably coupled to the grip wherein the locking mechanism can prevent unintended loosening of the grip nut once secured in place.

In embodiments, the base 30 can have a grip portion 40 on a grip end and a patio extension 42 on a patio end, wherein the patio extension 42 can be configured to be received in the patio hole 52 and can have patio threads 34 that at least partially extend along an exterior 43 of the patio extension 42 configured to secure the base in the patio hole and wherein the grip portion has a base grip thread 32 that extends at least partially along the grip portion 40 configured to engage the grip nut thread 18 and a base interior 36 that can be such as, for example, substantially funnel shaped, conical funnel, bell-shaped funnel, stepped funnel, tapered funnel, cylindrical funnel or the like. The base interior 36 can extend to a base hole wherein the base hole can be sized to except varying diameters of umbrella poles.

The base 30 can have the patio threads 34 extending from the grip portion 40 down the patio extension 42. The base grip threads 32 can be the male threads and match the grip nut threads 18 wherein the grip nut threads 18 can be female threads allowing the user to tighten the grip nut 12 onto the base 30. In certain embodiments, the patio extension 42 can have a stem 35 that can extend beyond the patio threads 34 and act as a support within the umbrella hole 52 within a second hole 38 extending from the base interior 36. The stem's 35 outer diameter can be such as, for example, the same diameter, smaller diameter or bigger diameter as the base grip threads 32 and the second hole 38 can be sized to fit varying size umbrella poles 50. The base 30 can be manufactured from such as, for example, plastic, stainless steel, Delrin, carbon steel, ceramic, composite, aluminum, or the like.

In embodiments, the umbrella holding device 10 can further comprise a ferrule 20 wherein the ferrule can have a ferrule top 22 and a ferrule bottom 24. The ferrule top 14 can have at least one tang 29 wherein the ferrule can be configured to be inserted into the grip hollow such that the ferrule top 22 engages the shoulder 15 such that when the base grip threads 32 engage the grip nut thread 18 the ferrule is pushed into the base interior 36 and the funnel shaped base interior exerts inward pressure on the ferrule wherein the at least one tang 29 has an inward force on the umbrella pole 50 keeping the umbrella pole secured within the umbrella holding device 10 and within the hole 52.

The at least one tang 29 can have a throat 28 that leads into at least one groove 26 which can be substantially near the ferrule top 22. The ferrule bottom 24 can have at least one tang 29 extending from the ferrule bottom towards substantially near the ferrule top 22 wherein the at least one tang is substantially angled to correspond with the funnel shaped base interior 36. The at least one tang 29 can have at least one slot 27 between each tang. In the prefer embodiments, the tang can be at least four tangs 29 with four slots 27 but in other embodiments there can be such as, for example, one tang, two tangs, three tangs, four tangs, five tangs, or the like.

The groove 26 can allow for the at least one tang 29 to be easily compressed. The at least one tang 29 can be substantially angled from substantially near the groove 26. The ferrule 20 can be any suitable shape or size and can be manufactured by such as, for example, stainless steel, plastic, carbon fiber, composite material, ceramics, wood, or the like. The at least one tang 29 can be coated or covered with non-slip material such as, for example, non-slip foam, non-slip rubber, epoxy quartz, anti-slip paint, or the like. In other embodiments, the base interior 36 can be lined with a friction-enhancing material to increase its grip on either the grip nut or the ferrule 20. The ferrule 20 can be composed of a flexible material that can expands outward or inward when an inward or outward pressure is exerted by the funnel-shaped base interior. The at least one tang 29 of the ferrule 20 can be configured to deform elastically under pressure from the funnel-shaped base interior 36 to securely grip the umbrella shaft 50. The ferrule 20 can be manufactured from Delrin, silicone, plastic, stainless steel, aluminum, carbon steel, ceramic, and composite In certain embodiments, the ferrule 20 can be replaceable to accommodate different size umbrellas. The at least one tang 29 can be configured with a barb that engages with the base interior 36 to align and lock the ferrule in place when inserted.

In embodiments, the grip nut 12 can be removably coupled to the base 30 wherein the ferrule 20 can be placed between the grip nut and the base. The grip nut 12 can compress the ferrule 20 into the base 30 wherein as the grip nut can be screwed onto the base the base interior 36 with a funnel shape decreases the inner diameter size pushing against the tangs 29 which pushes against the umbrella's pole 50 tightening the umbrella holding device 10 onto the umbrella pole. The patio, porch or pool deck can have a hole 52 wherein the umbrella holding device 10 can be placed into the hole and then screwed into the hole with the partially threaded exterior 34 wherein the partially threaded exterior allows the user to tighten the base into the patio, porch, umbrella sleeve or pool deck. Once the user has tightened the base 30 into the hole 52 the user can place the grip nut 12 and the ferrule 20 on the umbrella pole 50 and then place the umbrella into the base into the second hole 38. The user can then tighten down the grip nut 12 onto the base 30 wherein the shoulder 15 can be pushed against the ferrule top 22 wherein the grip nut can compress the ferrule 20 onto the pole 50 wherein the umbrella holding device 10 can securely hold the pole 50 in place. The hole in the porch, patio or pool deck can hold the pole 50 which can be such as, for example, umbrella pole, volleyball pole, basketball pole, tetherball pole, or the like.

In certain embodiments, the umbrella holding device 10 can further comprise a drainage channel 37 within the base 30 to allow water to escape from the patio hole, preventing accumulation around the umbrella pole and the threaded exterior portion of the grip portion 40 can be a self-locking thread to prevent loosening due to vibration or wind movement.

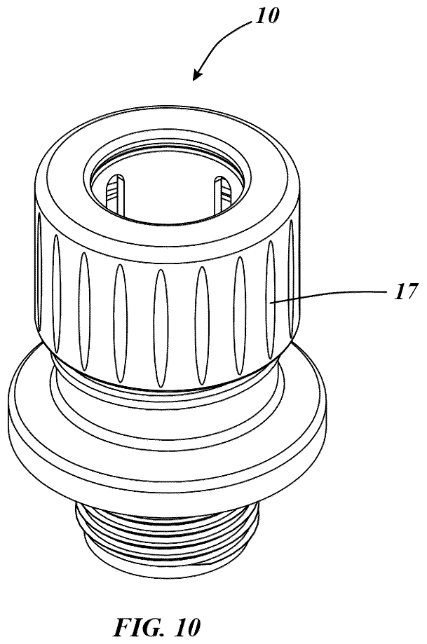

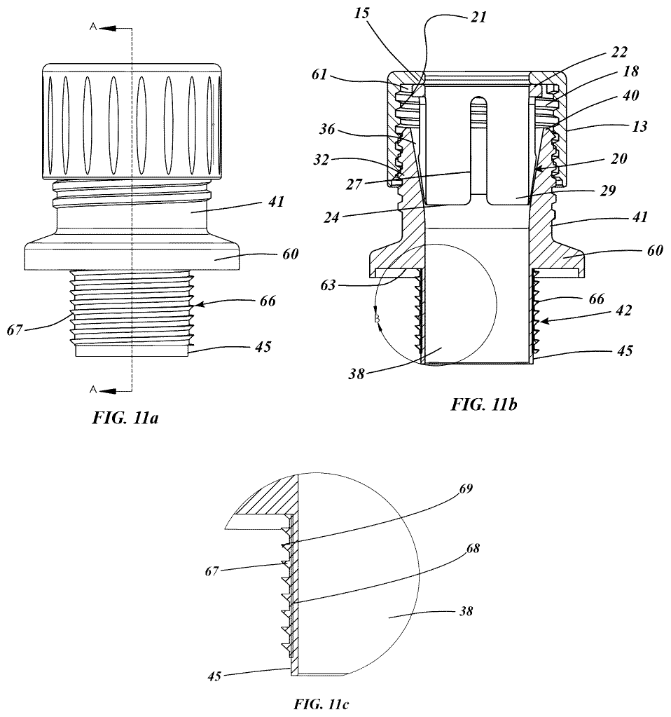

Referring to FIG. 10-11c another embodiment of an umbrella holding device is depicted. The umbrella holding device 10 can have a grip nut 12 that can be the upper component for securing an umbrella shaft 50. The grip nut 12 can have a grip exterior surface 13, which can be configured to allow a user to manually rotate and tighten the grip nut. The grip exterior 13 can include grip extrusion 17 which can be such as, for example, knurling, ridges, flats for a wrench, or the like. The grip nut 12 can have a grip interior 61 that defines a grip hollow 21 wherein the grip hollow 21 can provide an internal cavity within the grip nut that receives a ferrule 20 and partial portion of a base 30.

The grip interior 61 can be at least partially threaded with a grip nut thread 18. The threading can extend along all of the grip interior 61 surface or can extend along only a portion of the grip interior surface such as, for example, the threading can extend for 50% to 100% of the length of the grip interior, such as 60% to 90%, or for example 70% to 85%. The grip nut thread 18 can have various configurations such as, for example, the grip nut thread can be a standard thread form such as a Unified National thread, metric thread, or Acme thread. The thread can have various pitches, such as coarse pitch or fine pitch. For example, the thread can have a pitch of 1 mm to 5 mm, such as 1.5 mm to 3 mm, or for example approximately 2 mm. The selection of thread pitch can affect the mechanical advantage during tightening and the fineness of adjustment available. The grip nut thread 18 can be right-handed thread or, in some embodiments, can be left-handed thread. The grip nut thread 18 can be configured to engage corresponding base grip threads 32 on the base component 30. The dimensions of the grip hollow can be selected to accommodate the ferrule and to allow for proper engagement between the ferrule top 22 and the shoulder 15.

In embodiments. extending from the grip exterior 13 into the grip hollow is a shoulder 15. The shoulder 15 can project inwardly from the interior surface and defines a shoulder diameter. The shoulder 15 can serves as a stop or engagement surface for the ferrule 20. The shoulder 15 diameter can be dimensioned to accommodate the ferrule 20 top while preventing the ferrule from passing completely through the grip nut 12. The shoulder 15 can have various widths (measured in the radial direction) such as, for example, the shoulder can extend inwardly from the grip interior 61 surface by 2 mm to 15 mm, and even more preferably 3 mm to 10 mm, or still more preferrable 4 mm to 8 mm. The width of the shoulder 15 can be selected to provide adequate support for the ferrule top while not interfering with the operation of the ferrule 20.

In embodiments, the base 30 can have a base having a grip portion 40 on a grip end and a patio extension 42 on a patio end, wherein the grip portion can have a base grip portion 32 configured to engage the grip nut thread 18 and a base interior 36 that can be substantially funnel shaped. The base 30 can be a unitary structure formed as a single piece, or in embodiments, it can be formed from multiple pieces that can be joined together, such as, for example, by welding, threading, adhesive bonding, or mechanical fasteners. The grip portion 40 can be located at the upper end of the base 30 and can be configured to engage with the grip nut 12. The grip portion can have a generally cylindrical shape, though other shapes such as tapered, hexagonal, or square can be used in some embodiments. The base grip thread 32 on the grip portion 40 can be complementary to the threading 18 on the grip nut 12, such that when the grip nut 12 is rotated onto the grip portion 40, the threads 18, 32 can interlock to create a secure, adjustable connection.

The base grip thread 32 can extend along all of the grip portion's 40 length or can extend along only a part of the grip portion's length. For example, the threading can extend for 40% to 100% of the length of the grip portion, such as 50% to 90%, or for example 60% to 80%. The extent of threading can affect the range of adjustment available and the overall assembly characteristics. The grip portion 40 can have a grip external diameter 41, which can be measured at the outer extent of the threads such as, for example, the grip external diameter can be 25 mm to 90 mm, such as 40 mm to 80 mm, or for example 50 mm to 60 mm. The grip external diameter 41 can be selected based on the size of the grip nut and the structural requirements of the device.

The grip portion 40 can have a base interior 36 that can be substantially funnel shaped. The funnel shaped base interior 36 can be configured to taper inwardly, typically in a downward direction (from the grip end toward the patio end), to provide a compression surface. The funnel shape base interior 36 can allow the base interior to exert inward pressure on components positioned within it, particularly the ferrule 20. The funnel can have various taper angles. For example, the funnel can have a half-angle (measured from the vertical axis) of 5 degrees to 45 degrees, such as 10 degrees to 35 degrees, or for example 15 degrees to 30 degrees. Steeper angles can provide greater compression force but may require more vertical displacement of the ferrule, while shallower angles can provide more gradual compression with less vertical displacement. The base interior 36 can be smooth and can have a continuous funnel surface, or can include such as, for example, ribs, grooves, like. In other embodiments, the base interior 36 can have vertical ribs that can engage corresponding features on the ferrule 20 or can include a textured surface that can enhance friction between the base interior and the ferrule. The base interior 36 can extend through all or part of the base such as, for example, the base interior can extend from the top of the grip portion 40 downward into the body of the base and continuing through to connect with the hollow of the patio extension 42 creating a hole through the assembly for a umbrella pole 50 to fit in.

In embodiments, the base 30 can have a patio extension 42 that can extend from the grip end toward the patio end. The patio extension 42 can be configured to be inserted into a patio hole and can provide the physical connection between the umbrella holding device and the patio structure. The patio extension 42 can have various lengths depending on the depth of typical patio holes and the desired stability such as, for example, the patio extension 42 can have a length of 20 mm to 150 mm, such as 30 mm to 80 mm, or for example 40 mm to 50 mm. Longer patio extensions 42 can provide greater stability and can distribute loads over a larger area, while shorter patio extensions can be suitable for shallower patio holes or applications where compactness is desired. The patio extension 42 can have various cross-sectional shapes. For example, the patio extension can be cylindrical, which can be the most common configuration for compatibility with standard patio holes and in other embodiments, the patio extension can have a hexagonal, square, oval, or other cross-sectional shape depending on the cross section of the umbrella pole 50 being inserted into the patio extension.

The patio extension 42 can have an extension outer diameter 45 that can be dimensioned to fit within standard patio holes. The extension outer diameter 45 can be between 30 and 60 mm, though other sizes such as 40 mm to 50 mm can be used for different applications. For example, the extension outer diameter can be approximately 44 mm for compatibility with common patio table holes. The extension outer diameter 45 can be selected to provide a close fit within the patio hole while allowing for the addition of the thread. The patio extension 42 can be hollow and can provide a passage for the umbrella shaft if desired. If hollow, the patio extension can have an inner diameter that can be selected based on the umbrella shaft dimensions and structural requirements. For example, a hollow patio extension can have an inner diameter of 25 mm to 45 mm, such as 30 mm to 40 mm. The patio extension 42 can have a wall thickness or a material thickness that can provide adequate structural strength wherein the thickness can be such as, for example, between 0.1 mm and 3 mm, though other thicknesses such as 1 mm to 3 mm can be used depending on the material and load requirements. The patio extension 42 can be manufactured from various materials such as, for example, the patio extension can be manufactured from such as, for example, plastics, metals, ceramics, composites or the like.

In embodiments, a thread sleeve 66 can slide over the patio extension 42. The thread sleeve 66 may be removable or may be secured to the patio extension by, for example, an adhesive. The thread sleeve 66 may allow the patio extension to interface with threaded patio holes of various configurations such as, threaded patio holes, damage threaded patio holes, missing threaded patio holes, or the like. The thread sleeve 66 can be removable, meaning it can be installed onto the patio extension, removed, and replaced as needed so that, for example, users can replace worn thread sleeves 66 without replacing the entire device, users can change thread sleeves 66 to accommodate different patio holes, and manufacturers can provide a single base design with multiple thread sleeve options.

The thread sleeve 66 can slide over the patio extension 42 wherein this sliding installation can be accomplished by pushing or pressing the thread sleeve onto the patio extension. The fit between the thread sleeve and patio extension can range from a tight interference fit (requiring significant force to install) to a loose clearance fit (allowing easy installation and removal), depending on the specific design requirements. In other embodiments, the thread sleeve 66 can include a slit along its length that can allow the thread sleeve to be expanded slightly during installation, making installation easier. After installation, the slit can close, and the thread sleeve can return to its nominal dimensions.

After installation, the thread sleeve 66 may be secured to the patio extension 42 by any method known to those having skill in the art. For example, a screw may be installed through the thread sleeve 66 and the patio extension 42, an adhesive may be applied to the patio extension 42 before the thread sleeve 66 is applied and then allowed to cure, or the thread sleeve 66 may be over-molded onto the patio extension.

In embodiments, the thread sleeve 66 can give the patio extension an at least partially threaded exterior. The threads 67 on the thread sleeve 66 exterior can engage corresponding threads in the patio hole, allowing the device to be threaded into the patio hole. This threaded engagement can provide secure retention and can allow for precise height adjustment of the device. The thread sleeve 66 can cover all or part of the patio extension such as, for example, the thread sleeve can extend along 50% to 100% of the length of the patio extension, such as 60% to 95%, or for example 70% to 90%. The coverage can be selected based on the depth of the threaded portion of the patio hole and the desired range of height adjustment.

In embodiments, the thread sleeve 66 can be composed of a pliable material that allows the thread sleeve 66 to deform slightly under compressive forces. In some embodiments, when the patio extension with the thread sleeve 66 is threaded into the patio hole, the thread sleeve can compress against the patio extension. This compression can occur because the outer diameter of the thread sleeve (at the thread crests) can be slightly larger than the inner diameter of the patio hole, or because the threading action can generate compressive forces between the mating threads wherein this compression can create a friction hold that can hold the patio extension in the patio hole. The friction hold can supplement or, in some cases, can replace the holding force provided by the threads themselves. This can be particularly beneficial if the patio hole threads are worn, if the thread fit is loose, or if additional holding force is desired.

The pliable material can be various materials that can exhibit the desired deformation characteristics such as, for example, the pliable material can be at least one of rubber, Buna-N (nitrile rubber), thermoplastic copolyester (such as materials sold under the trade name Hytrel), thermoplastic polyurethane and the like. Each of these materials can offer different balances of pliability, durability, chemical resistance, temperature resistance, and cost. Rubber can provide excellent pliability and friction characteristics and can be relatively inexpensive. Rubber can be natural rubber or synthetic rubber. Buna-N can provide good oil and chemical resistance along with good mechanical properties, making it suitable for applications where exposure to oils, greases, or chemicals might occur. Thermoplastic copolyester can provide excellent abrasion resistance, chemical resistance, and can maintain properties over a wide temperature range. Thermoplastic polyurethane can provide excellent abrasion resistance, good flexibility, and can be easily processed by injection molding or extrusion. Other pliable materials can also be used. For example, the thread sleeve can be made from silicone rubber, EPDM (ethylene propylene diene monomer) rubber, neoprene, thermoplastic elastomers (TPE), or other elastomeric or flexible materials. The material selection can be based on the specific application requirements, such as, for example, outdoor exposure, temperature extremes, chemical exposure, or cost constraints.

The thread sleeve 66 can have a sleeve inner diameter 68, and the patio extension can have an extension outer diameter 45 where the relationship between these two diameters can affect the fit and installation characteristics of the thread sleeve. In some embodiments, the sleeve inner diameter 68 can equal the extension outer diameter 45 wherein this can provide a tight, friction-fit connection between the thread sleeve and the patio extension. With this configuration, the thread sleeve 66 may need to be stretched slightly during installation, and once installed, can grip the patio extension securely. This can prevent the thread sleeve 66 from sliding or rotating on the patio extension during threading operations. In other embodiments, the extension outer diameter 45 can be slightly larger than the sleeve inner diameter 68. For example, the extension outer diameter can be 0.76 mm greater than the sleeve inner diameter. This interference fit can ensure that the thread sleeve is firmly retained on the patio extension. The specific amount of interference can be selected based on the pliability of the thread sleeve material, with more pliable materials allowing for greater interference.

In still other embodiments, the sleeve inner diameter 68 can be slightly larger than the extension outer diameter, providing a clearance fit. For example, the sleeve inner diameter can be 0.1 mm to 2 mm larger than the extension outer diameter, such as 0.2 mm to 1 mm larger. This can allow for easy installation and removal of the thread sleeve while still providing adequate retention through friction during normal use.

The thread sleeve 66 can have threads 67 on its exterior surface. The sleeve thread 66 can be configured to engage threads in the patio hole. The sleeve thread 66 can have various thread forms such as, for example, the sleeve thread can be a V-thread (with a triangular profile), an Acme thread (with a trapezoidal profile), a buttress thread, or the like. The thread form can be selected based on the typical thread form found in patio holes and the desired strength and ease of threading. In some embodiments, the sleeve thread 67 can have a flat top 69 wherein the flat top (also called a truncated thread) can be created by removing or flattening the crest of the thread wherein this configuration can provide several advantages such as, for example, a flat top can reduce stress concentrations at the thread crest, can make the thread more resistant to damage, can improve the threading action by providing a broader contact surface, and can be easier to manufacture in some processes. The flat top 69 can have various widths such as, for example, the flat top can have a width of 0.5 mm to 3 mm, such as 1 mm to 2 mm. The width can be selected to balance the benefits of the flat top against the reduction in thread engagement. The sleeve thread 67 can extend (measured in height from root to crest) various distances such as, for example, the sleeve thread can extend between 25 and 50 mm, though other ranges such as 15 mm to 60 mm can be used. The thread extension (thread height) can affect the strength of the thread engagement and the ease of threading such as, for example, taller threads can provide stronger engagement but may be more prone to damage and may require more material.

In embodiments, the thread sleeve 66 can have a hardness that can affect its deformation characteristics, durability, and friction properties. The hardness can be measured on various scales, such as the Shore A durometer scale (for softer materials), the Shore D durometer scale (for harder materials), or other hardness scales. In some embodiments, the thread sleeve can have a hardness between Shore 30 and 95 on the durometer hardness scale. This range can encompass materials from relatively soft and highly pliable (Shore A 30, similar to a rubber band) to harder and less pliable (Shore A 95 or Shore D 30-40, similar to a hard plastic). The specific hardness can be selected based on the application requirements such as, for example, softer materials (Shore A 30-60) can provide excellent pliability and friction characteristics and can be particularly effective at creating a friction hold. However, they may be less durable and may be more prone to tearing or abrasion. Harder materials (Shore A 70-95 or Shore D 30-50) can provide better durability and abrasion resistance and can maintain their shape better, but may provide less pliability and less friction hold. The hardness selection can also depend on the patio hole material such as, for example, a softer thread sleeve might be preferred for metal patio holes to avoid scratching or marring the surface, while a harder thread sleeve might be preferred for plastic or concrete patio holes where durability is more important.

In embodiments, the base 30 can have a flare 60 which can extend past the grip external diameter 41 in a direction orthogonal to the direction that the patio extension extends from the grip portion. The flare 60 can provide a transitional structure between the grip portion and the patio extension, and can serve various functional and aesthetic purposes. The flare 60 can extend radially outward from the base, creating a wider section that can provide a more finished appearance and can cover the junction between the grip nut and the base when assembled. The flare 60 can extend past the grip exterior of the grip nut, such that when the device is assembled, the flare can partially or completely surround the lower portion of the grip nut. The flare 60 can extend various distances in the radial direction. For example, the flare can extend between 70 and 100 mm in diameter (measured from the centerline), or can extend between 10 mm and 50 mm beyond the grip external diameter, such as 15 mm to 40 mm, or for example 20 mm to 35 mm. The extent of the flare 60 can be selected based on aesthetic preferences and functional requirements such as protecting the grip nut threads or providing a drip edge to direct water away from the patio hole. The flare 60 can have various shapes such as, for example, the flare can be a flat disk, a conical section, a curved surface, or can have a more complex three-dimensional shape. The flare 60 can be smooth or can include decorative features such as ribs, patterns, or textures.

In embodiments, the flare 60 can have a lip and a hollow that together can define a collar 63. The collar 63 can provide a receiving area or seat for the thread sleeve 66. The collar 63 can be configured such that the thread sleeve 66 fits into the collar when the patio extension is fully inserted into the thread sleeve. The lip can be an upward-extending rim or edge that can provide a lateral boundary for the collar 63. The hollow can be a recessed area between the lip and the main body of the base. Together, the lip and hollow can create a cavity or channel that can receive and retain the upper portion of the thread sleeve 66. An adhesive may be used to secure the thread sleeve 66 to the patio extension 42 and/or to the collar 63.

The collar 63 can provide several advantages such as, for example, the collar can help position the thread sleeve correctly on the patio extension, can prevent the thread sleeve from sliding upward during installation, can provide a clean, integrated appearance, can protect the upper edge of the thread sleeve from damage and the like. The collar 63 can have various dimensions. For example, the collar can have a depth (measured vertically) of 2 mm to 20 mm, such as 5 mm to 15 mm, or for example 8 mm to 12 mm. The collar can have a width (measured radially) that can accommodate the wall thickness of the thread sleeve, such as 1 mm to 30 mm, or for example 10 mm to 25 mm.

In embodiments, the umbrella holding device 10 can include a ferrule 20 that can serve to grip the umbrella shaft. The ferrule 20 can have various overall shapes such as, for example, the ferrule can be generally cylindrical, conical, or can have a more complex shape that can combine cylindrical and conical sections. The ferrule 20 shape can be selected to work effectively with the funnel-shaped base interior and to provide appropriate gripping force on the umbrella shaft.

The ferrule 20 can have a ferrule top 22 wherein the ferrule top can be the uppermost portion of the ferrule and can be configured to engage the shoulder 15 in the grip nut. The ferrule top 22 can be a flat surface, a slightly curved surface, or can include features such as ribs or protrusions that can engage corresponding features on the shoulder. The ferrule top 22 can have various diameters depending on the overall size of the device such as, for example, the ferrule top can 22 have a diameter of such as, for example, 15 mm to 55 mm, 30 mm to 50 mm, and even more preferably 35 mm to 45 mm. The diameter can be selected to fit properly within the grip hollow and to engage the shoulder 15 effectively.

In embodiments, the ferrule 20 can include at least one tang 29 where in the tangs can be such as, for example, projections, fingers, or segments that can extend from the ferrule body and can be configured to contact and grip the umbrella shaft. The tangs 29 can provide the gripping function of the ferrule. The ferrule 66 can include various numbers of tangs 29 such as, for example, the ferrule can include two tangs (providing gripping on opposite sides), three tangs (providing three-point contact), four tangs (providing four-point contact and good distribution of gripping force), or the like. The number of tangs 29 can affect the uniformity of the gripping force and the adaptability to different umbrella shaft sizes and shapes.

The tangs 29 can extend inwardly from the ferrule 20 body, projecting toward the center where the umbrella shaft can be located. The tangs 29 can be equally spaced around the circumference of the ferrule, or in some embodiments, can be unevenly spaced. The tangs 29 can have various lengths such as, for example, the tangs can extend by 15 mm to 80 mm, such as 20 mm to 60 mm, or for example 40 mm to 50 mm. The tangs 29 can be rigid or flexible wherein flexible tangs can be manufactured from a material that can bend or flex, allowing the tangs to accommodate different umbrella shaft diameters and to conform to irregular shaft surfaces. Rigid tangs 29 can provide more positive gripping but may require more precise matching to the umbrella shaft diameter.

The inner surfaces of the tangs 29 (the surfaces that contact the umbrella shaft) can be smooth or can include features to enhance gripping such as, for example, the tang 29 surfaces can include such as, for example, ridges, grooves, knurling, a textured pattern or the like that can increase friction against the umbrella shaft. In some embodiments, the tang 29 surfaces can include a friction-enhancing coating or material configured to increase grip and prevent slippage during use. The friction-enhancing coating or material can comprise a rubber or elastomeric layer applied to one or more surfaces of the tang which can be suitable elastomeric materials such as, for example, natural rubber, synthetic rubber, silicone rubber, thermoplastic elastomers (TPE), thermoplastic polyurethane (TPU), ethylene propylene diene monomer (EPDM) rubber, nitrile rubber, neoprene, or combinations thereof.

The friction-enhancing coating may be applied using various methods, including overmolding, dip coating, spray coating, adhesive bonding, or mechanical attachment. In some implementations, the coating has a thickness ranging from approximately 0.1 mm to 5 mm, more preferably from 0.5 mm to 3 mm, to provide optimal grip without significantly altering the dimensional tolerances of the tang. The surface of the friction-enhancing material may be textured or patterned to further increase the coefficient of friction. Such texturing may include ridges, knurling, dimples, cross-hatching, or other geometric patterns that enhance tactile grip. In certain embodiments, the friction-enhancing coating exhibits a coefficient of friction greater than 0.5, preferably greater than 0.8, and more preferably greater than 1.0 when measured against human skin or typical glove materials. The friction-enhancing material can also provide additional benefits such as vibration dampening, electrical insulation, thermal insulation, or cushioning to improve user comfort and reduce hand fatigue during extended use. In some variations, the elastomeric layer is chemically resistant to oils, solvents, or other substances commonly encountered in the intended application environment, ensuring long-term durability and maintained grip performance.

The ferrule 20 can be configured to be inserted into the grip hollow of the grip nut. When inserted, the ferrule top can engage the shoulder wherein this engagement can position the ferrule at a specific location within the assembly and can provide a surface against which compression forces can be applied. When the threaded exterior portion of the base engages the grip nut thread (i.e., when the grip nut is threaded onto the base), the ferrule can be pushed downward into the base interior. As the grip nut is tightened, it can push on the ferrule top, forcing the ferrule deeper into the funnel-shaped base interior. Because the base interior is funnel shaped (tapering inwardly), as the ferrule is pushed deeper into the funnel, the walls of the funnel can contact the outer surface of the ferrule. The funnel shaped base interior can exert inward pressure on the ferrule. This inward pressure can cause the ferrule to compress radially inward.

As the ferrule compresses inward, the tangs can move inward, gripping any umbrella shaft positioned within the ferrule. The gripping force can increase as the grip nut is tightened further. This provides an adjustable gripping mechanism where the user can control the gripping force by adjusting how tightly the grip nut is threaded onto the base. To release the umbrella, the grip nut can be loosened (rotated in the opposite direction), which can reduce the downward force on the ferrule. As the ferrule moves upward in the funnel, the inward pressure from the base interior can decrease, allowing the tangs to move outward and release the umbrella shaft.

In some embodiments, the ferrule 20 can be replaceable. This can allow users to change ferrules 20 to accommodate different size umbrellas or to replace worn or damaged ferrules without replacing the entire device. Different ferrules 20 can be provided with different internal diameters (the diameter of the circle formed by the inner ends of the tangs when in the relaxed position). For example, small ferrules might accommodate umbrella shafts from 20 mm to 30 mm in diameter, medium ferrules might accommodate shafts from 28 mm to 38 mm in diameter, and large ferrules might accommodate shafts from 36 mm to 48 mm in diameter. In embodiments, the ferrule 20 can be manufactured from various materials such as, for example, aluminum, steel, stainless steel, brass, plastics such as ABS, nylon, polycarbonate, or acetal, or the like.

In embodiments to assemble the umbrella holding device, a user can first select an appropriate thread sleeve 66. The selection can be based on the patio hole dimensions, thread configuration, and material. If multiple thread sleeves are provided, the user can compare the thread sleeves to the patio hole to determine which provides the best fit. The selected thread sleeve 66 can then be slid over the patio extension of the base and may be secured to the patio extension 42. The thread sleeve 66 can be pushed onto the patio extension 42 until it is fully seated. If the base includes a flare 60 with a collar 63, the thread sleeve 66 can be positioned such that the upper portion of the thread sleeve fits into the collar 63. The collar can help ensure that the thread sleeve is properly positioned and can provide a finished appearance.

If the fit between the thread sleeve 66 and patio extension 42 is tight, the user may need to apply some force to install the thread sleeve. In some cases, lubricant (such as water, soap solution, or silicone lubricant) can be applied to ease installation, though the lubricant should be allowed to dry or should be removed before threading the device into the patio hole to avoid reducing the friction hold. In a particular embodiment, a wet adhesive may serve as a lubricant to allow the thread sleeve 66 to be positioned on the patio extension 42 before drying and securing the thread sleeve 66 in place. Next, the appropriate ferrule can be selected based on the umbrella shaft size. If the device is provided with multiple ferrules, the user can measure the umbrella shaft diameter or can test-fit different ferrules to determine which provides the best fit. The ferrule can be inserted into the grip hollow of the grip nut. The ferrule can be oriented so that the ferrule top faces upward and can engage the shoulder. The ferrule can be pushed into the grip hollow until the ferrule top contacts the shoulder. Some ferrules may have a keying feature or specific orientation requirement to ensure proper installation.

With the thread sleeve assembled onto the patio extension, the device can be threaded into the patio hole. The user can align the threads 67 of the thread sleeve 66 with the threads of the patio hole and can begin rotating the device. As the device is threaded in, the threads 67 can engage, and the device can move downward into the patio hole. As the device is threaded deeper, the pliable material of the thread sleeve can begin to compress. This compression can occur between the patio extension (on the inside) and the patio hole wall (on the outside). The compression can create a friction hold that can supplement the thread engagement. The user can continue threading the device until it reaches the desired depth. The desired depth can be selected based on aesthetic preferences, the height of the patio table or furniture, and the amount of thread engagement desired for stability. In most applications, the device can be threaded in until the flare 60 (if present) contacts the top surface of the patio table or until the threads are fully engaged.

Once the device is installed in the patio hole, the umbrella can be installed. The user can first ensure that the grip nut is loosened sufficiently that the ferrule is not exerting significant gripping force. The umbrella shaft can then be inserted into the device. The umbrella shaft can pass through the grip nut, through the center of the ferrule, and down into the base interior. If the patio extension is hollow, the umbrella shaft can extend into the patio extension as well. The umbrella can be inserted to the desired depth. With the umbrella in position, the grip nut can be tightened. As the grip nut is rotated (typically clockwise), it can thread onto the grip portion of the base, moving downward. As the grip nut moves downward, it can push on the ferrule top, forcing the ferrule deeper into the funnel-shaped base interior. The user can continue tightening the grip nut until the umbrella is held securely. The required tightness can vary depending on the umbrella weight, wind conditions, and user preference. The user can test the umbrella by attempting to lift or rotate it to verify that it is held securely.

To remove the umbrella, the user can loosen the grip nut by rotating it in the opposite direction (typically counterclockwise). As the grip nut loosens, the downward force on the ferrule can decrease, and the ferrule can move upward in the funnel-shaped base interior. This can reduce the inward pressure on the ferrule, allowing the tangs to relax and release the umbrella shaft. Once the grip nut is sufficiently loosened, the umbrella shaft can be lifted out of the device. The device can remain installed in the patio hole until the user wishes to remove it. To remove the device from the patio hole, the user can rotate the entire device in the opposite direction from installation (typically counterclockwise). As the device is unthreaded, it can move upward and can eventually be completely removed from the patio hole. If the user wishes to disassemble the device, the ferrule can be removed from the grip nut, and the thread sleeve can be pulled off the patio extension. The grip nut can be unscrewed from the base if desired. This modularity can allow for easy maintenance, component replacement, or storage.

A method can be provided for providing an umbrella holding device to a user. This method can encompass both the physical provision of the device and the provision of information for proper use. The method can include providing the various components of the umbrella holding device wherein the method can include providing a grip nut having a grip exterior, a grip interior that defines a grip hollow, and a shoulder extending from the grip exterior into the grip hollow defining a shoulder diameter, wherein the grip interior is at least partially threaded with a grip nut thread. The method further includes providing a base having a grip portion on a grip end and a patio extension on a patio end, wherein the grip portion has a base grip thread configured to engage the grip nut thread and a base interior that is substantially funnel shaped.

Additionally, the method may include providing at least one removable thread sleeve that slides over the patio extension to give the patio extension an at least partially threaded exterior, and a ferrule having a ferrule top and at least one tang, the ferrule configured to be inserted into the grip hollow such that the ferrule top engages the shoulder such that when the threaded exterior portion engages the grip nut thread the ferrule is pushed into the base interior and the funnel shaped base interior exerts inward pressure on the ferrule.

The components can be pre-assembled, partially assembled, or completely unassembled, depending on manufacturing and shipping considerations. In some embodiments, the at least one removable thread sleeve can be a plurality of removable thread sleeves of differing dimensions. For example, a kit can include two, three, or more thread sleeves with different outer diameters, thread pitches, thread forms, lengths, or other dimensional variations. By providing multiple thread sleeves of differing dimensions, users can be allowed to select an appropriate thread sleeve for their specific patio hole configuration. This can greatly enhance the versatility of the device and can reduce the need for users to precisely measure their patio holes before purchasing the device. An adhesive or attachment device may be provided to allow the user to secure the selected thread sleeve in place.

The multiple thread sleeves can be clearly marked or labeled to help users identify the differences. For example, the thread sleeves can be marked with their dimensions, thread specifications, or can be color-coded. The packaging or instructions can include guidance on how to select the appropriate thread sleeve, such as a sizing chart or measurement guide. In some embodiments, the at least one removable thread sleeve can be a plurality of removable thread sleeves made of differing materials. For example, a kit might include thread sleeves made from rubber, Buna-N, thermoplastic copolyester, and thermoplastic polyurethane, allowing users to select the material that best suits their application. By providing thread sleeves made of differing materials, users can be allowed to select an appropriate thread sleeve based on environmental conditions, patio hole material, desired friction characteristics, or other material-related factors. For example, a user might select a chemically resistant thread sleeve for use near a pool where chlorine exposure might occur or might select a very soft thread sleeve for use with a metal patio table to avoid scratching. Like the dimensionally different thread sleeves, the materially different thread sleeves can be marked or labeled to help users identify them. The marking can include the material name, material properties, recommended applications, or can use color coding.

In closing, it is to be understood that although aspects of the present specification are highlighted by referring to specific embodiments, one skilled in the art will readily appreciate that these disclosed embodiments are only illustrative of the principles of the subject matter disclosed herein. Therefore, it should be understood that the disclosed subject matter is in no way limited to a particular methodology, protocol, and/or reagent, etc., described herein. As such, various modifications or changes to or alternative configurations of the disclosed subject matter can be made in accordance with the teachings herein without departing from the spirit of the present specification. Lastly, the terminology used herein is for the purpose of describing particular embodiments only and is not intended to limit the scope of the present disclosure, which is defined solely by the claims. Accordingly, embodiments of the present disclosure are not limited to those precisely as shown and described.

Certain embodiments are described herein, including the best mode known to the inventors for carrying out the methods and devices described herein. Of course, variations on these described embodiments will become apparent to those of ordinary skill in the art upon reading the foregoing description. Accordingly, this disclosure includes all modifications and equivalents of the subject matter recited in the claims appended hereto as permitted by applicable law. Moreover, any combination of the above-described embodiments in all possible variations thereof is encompassed by the disclosure unless otherwise indicated herein or otherwise clearly contradicted by context.

I claim:

1. An umbrella holding device for securing an umbrella in a patio hole on a patio, porch or pool deck, the holding device comprising:
a grip nut having a grip exterior, a grip interior that defines a grip hollow, and a shoulder extending from the grip exterior into the grip hollow defining a shoulder diameter wherein the grip interior is at least partially threaded with a grip nut thread;
a base having a grip portion on a grip end and a patio extension on a patio end, wherein the grip portion has an at least partially threaded exterior portion configured to engage the grip nut thread and a base interior that is substantially funnel shaped;
a thread sleeve positioned over the patio extension to give the patio extension an at least partially threaded exterior; and
a ferrule having a ferrule top at least one tang, the ferrule configured to be inserted into the grip hollow such that the ferrule top engages the shoulder such that when the threaded exterior portion engages the grip nut thread the ferrule is pushed into the base interior and the funnel shaped base interior exerts inward pressure on the ferrule.

2. The umbrella holding device according to claim 1, wherein the thread sleeve is composed of a pliable material that compresses against the patio extension when the patio extension with the thread sleeve is threaded into the patio hole to create a friction hold that holds the patio extension in the patio hole.

3. The umbrella holding device according to claim 2, wherein the pliable material is at least one of rubber, Buna-N, thermoplastic copolyester and thermoplastic polyurethane.

4. The umbrella holding device according to claim 1, wherein the at least partially threaded exterior portion of the grip portion has a grip external diameter, and wherein the base has a flare that extends past the grip external diameter in a direction orthogonal to the direction that the patio extension extends from the grip portion.

5. The umbrella holding device according to claim 4, wherein the flare has a lip and a hollow that together define a collar into which the thread sleeve fits when the patio extension is fully inserted into the thread sleeve.

6. The umbrella holding device according to claim 5, wherein the flare extends past the grip exterior.

7. The umbrella holding device according to claim 5, wherein the flare extends between 70 and 100 mm.

8. The umbrella holding device according to claim 1, wherein the thread sleeve has a sleeve thread and wherein the sleeve thread has a flat top.

9. The umbrella holding device according to claim 1, wherein the thread sleeve has a sleeve thread and wherein the sleeve thread extends between 25 and 50 mm.

10. The umbrella holding device according to claim 1, wherein the thread sleeve has a sleeve inner diameter and the patio extension has an extension outer diameter and wherein the sleeve inner diameter equals the extension outer diameter.

11. The umbrella holding device according to claim 1, wherein the thread sleeve has a sleeve inner diameter, and the patio extension has an extension outer diameter and wherein the extension outer diameter is 0.76 mm greater than the sleeve inner diameter.

12. The umbrella holding device according to claim 1, wherein the patio extension has an extension outer diameter between 40 and 50 mm.

13. The umbrella holding device according to claim 1, wherein the thread sleeve has a hardness between Shore 30 and 95 on the durometer hardness scale.

14. The umbrella holding device according to claim 1 wherein the thread sleeve is secured to the patio extension by an adhesive.

15. A method for providing an umbrella holding device for securing an umbrella in a patio hole on a patio, porch or pool deck to a user, the method comprising the acts of:
providing:
a grip nut having a grip exterior, a grip interior that defines a grip hollow, and a shoulder extending from the grip exterior into the grip hollow defining a shoulder diameter wherein the grip interior is at least partially threaded with a grip nut thread;
a base having a grip portion on a grip end and a patio extension on a patio end, wherein the grip portion has an at least partially threaded exterior portion configured to engage the grip nut thread and a base interior that is substantially funnel shaped
at least one thread sleeve that fits over the patio extension to give the patio extension an at least partially threaded exterior; and
a ferrule having a ferrule top at least one tang, the ferrule configured to be inserted into the grip hollow such that the ferrule top engages the shoulder such that when the threaded exterior portion engages the grip nut thread the ferrule is pushed into the base interior and the funnel shaped base interior exerts inward pressure on the ferrule.

16. The method according to claim 15, wherein the ferrule is replaceable to accommodate different size umbrellas, the method further comprising instructing the user to assemble the thread sleeve onto the patio extension and thread the patio extension into a patio hole.

17. The method according to claim 15, wherein the at least one thread sleeve is a plurality of thread sleeves of differing dimensions and wherein the method further comprises allowing the user to select an appropriate thread sleeve.

18. The method according to claim 15, wherein the at least one thread sleeve is a plurality of thread sleeves made of differing materials and wherein the method further comprises allowing the user to select an appropriate thread sleeve.

19. The method according to claim 15 further comprising securing the thread sleeve to the patio extension via an adhesive.

20. The method according to claim 15 further comprising providing an adhesive and instructing the user to apply the adhesive to secure the thread sleeve to the patio extension.
